(19) United States
(12) Patent Application Publication
(10) Pub. No.: US 2016/0102495 A1
(43) Pub. Date: Apr. 14, 2016

(54) MOUNTING ARRANGEMENT FOR LADDER ASSEMBLY OF MACHINE

(71) Applicant: Caterpillar Inc., Peoria, IL (US)

(72) Inventors: Murugesan Muthusamy, Erode (IN); Nicholas P. Huttsell, Decatur (IL)

(73) Assignee: Caterpillar Inc., Peoria, IL (US)

(21) Appl. No.: 14/972,119

(22) Filed: Dec. 17, 2015

(51) Int. Cl. E06C 5/04; F16M 13/02

(52) U.S. Cl. CPC E06C 5/04; F16M 13/02; F16M 2200/024

(57) ABSTRACT

A mounting arrangement for a ladder assembly of a machine is provided. The mounting arrangement includes a support member. The support member is connected to a first end of the ladder assembly. The mounting arrangement also includes a mounting member. The mounting member is adapted to connect the support member and the frame of a machine. The mounting arrangement further includes a hinge member. The hinge member is disposed between the support member and the mounting member. The mounting arrangement includes a first latch assembly, The first latch assembly is adapted to hold the ladder assembly in the displaced position. The mounting arrangement also includes a second latch assembly. The second latch assembly is adapted to couple the ladder assembly with the first beam associated with frame of the machine. The second latch assembly includes a second mounting bracket. The second mounting bracket is coupled to the first beam.

### TECHNICAL FIELD

The present disclosure relates to a ladder assembly for a machine, and more particularly relates to a mounting arrangement for the ladder assembly of the machine.

### BACKGROUND

Large mining trucks and other large machines are known to employ ladders to provide access to the machine's engine compartment from the vehicle bed. These ladders provide access to the operator for performing periodic maintenance or repairs on the engine. However many current access ladders are difficult to use by individuals attempting to enter engine housing of a machine. Sometimes this task is made even more difficult if the individual utilizing these access ladders is an older individual or is carrying heavy, oversized equipment. Generally, access ladders or step groups, although convenient, present a number of problems when an engine is assembled or disassembled to a machine. These access ladders usually tend to have fasteners which are accessible only from the engine. If the engine has to be serviced, these access ladders have to be unbolted. When these access ladders are unbolted it becomes difficult for an operator or a serviceman to climb up on to a hood after servicing the engine.

U.S. Pat. No. 5,813,494 ('494 patent) describes an access ladder assembly for an agricultural machine having a body with an elevated operator's station. The ladder assembly includes a ladder that is mounted to the frame of the machine by a pivot mechanism that allows the ladder to be moved in either rotational direction about both a generally horizontal axis and a generally vertical axis. A locking mechanism releasably holds the ladder in an angularly adjusted position about both of these axes. A release mechanism conveniently located relative to the operator's station controls operation of the locking mechanism. The ladder assembly further includes rail structure carried by the ladder and movable about a generally vertical axis to either of two adjusted positions. However, the '494 patent does not disclose a tiltable ladder assembly to reach on top of the machine.

### SUMMARY OF THE DISCLOSURE

In one aspect of the present disclosure, a mounting arrangement for a ladder assembly of a machine is provided. The mounting arrangement includes a support member. The support member is connected to a first end of the ladder assembly. The mounting arrangement also includes a mounting member. The mounting member is adapted to connect the support member and the frame of a machine, The mounting member includes a first flange portion. The first flange portion is coupled to a first beam associated with the frame of the machine via a plurality of first fastening members. The mounting member also includes a second flange portion. The second flange portion extends from the first flange portion. The mounting member further includes a third flange portion. The third flange portion extends from the second flange portion. The third flange portion is coupled to a second beam associated with the frame of the machine via a plurality of second fastening members. The mounting arrangement further includes a hinge member. The hinge member is disposed between the support member and the mounting member. The hinge member includes a first flange member. The first flange member is attached to the second flange portion of the mounting member. The hinge member also includes a second flange member. The second flange member is coupled to the support member. The first flange member and the second flange member are coupled with each other to move the ladder assembly between a normal position and a displaced position about a rotational axis of the hinge member. The mounting arrangement includes a first latch assembly. The first latch assembly is adapted to hold the ladder assembly in the displaced position. The first latch assembly includes a first mounting bracket. The first mounting bracket is coupled to the third flange portion of the mounting member. The first latch assembly also includes a first latch member. The first latch member is coupled to the first mounting bracket. The first latch member engages the support member with the third flange portion of the mounting bracket in the displaced position of the ladder assembly. The first latch member disengages the support member in the normal position of the ladder assembly. The mounting arrangement also includes a second latch assembly. The second latch assembly is adapted to couple the ladder assembly with the first beam associated with frame of the machine. The second latch assembly includes a second mounting bracket. The second mounting bracket is coupled to the first beam. The second latch assembly also includes a second latch member. The second latch member is coupled to the second mounting bracket. The second latch member engages the ladder assembly with the first beam in the normal position of the ladder assembly. The second latch member disengages the ladder assembly form the first beam in the displaced position of the ladder assembly.

Other features and aspects of this disclosure will be apparent from the following description and the accompanying drawings.

### BRIEF DESCRIPTION OF THE DRAWINGS

FIG. 1 is a perspective view of an exemplary machine, according to an embodiment of the present disclosure;

FIG. 2 is a perspective view of a mounting arrangement used for coupling the ladder assembly with a frame of the machine;

FIG. 3 is an exploded view of the mounting arrangement used for coupling the ladder assembly with the frame of the machine;

FIG. 4 is an enlarged view of a second latch assembly of the machine; and

FIG. 5 is a perspective view of the ladder assembly in a displaced position.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

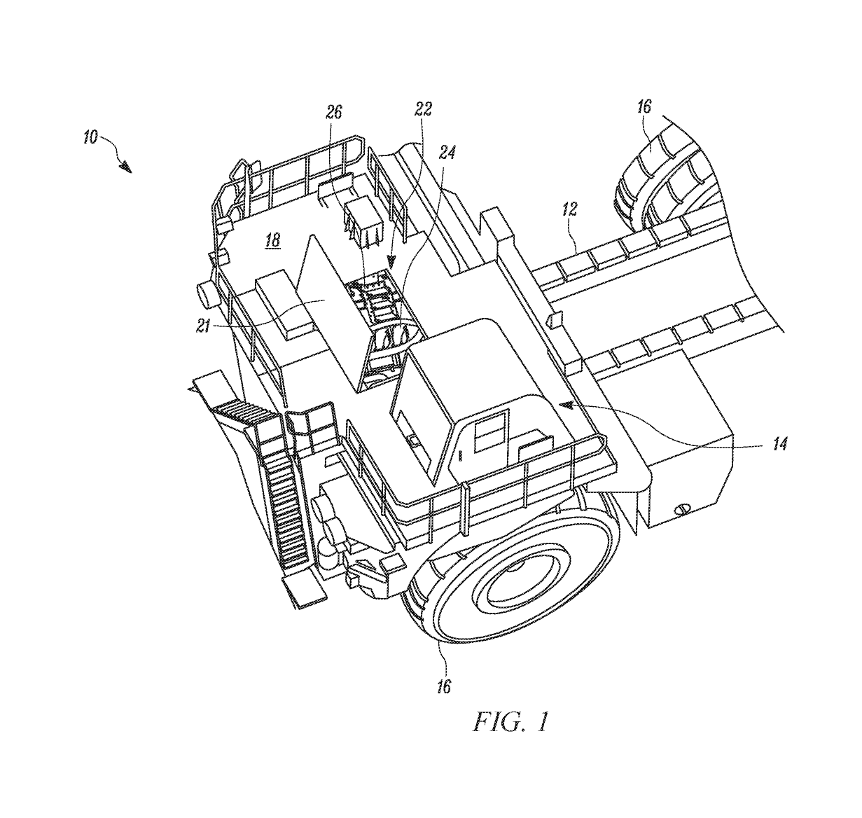

Referring to FIG. 1 an exemplary machine 10 is shown. In an example, the machine 10 is a mining truck. Although a mining truck is shown in FIG. 1, it should be noted that the machine 10 may alternatively be embodied in the form of a haul truck, an articulated truck, an off-highway truck or other machines typically employed in applications such as mining, forestry, waste management, construction, agriculture, etc.

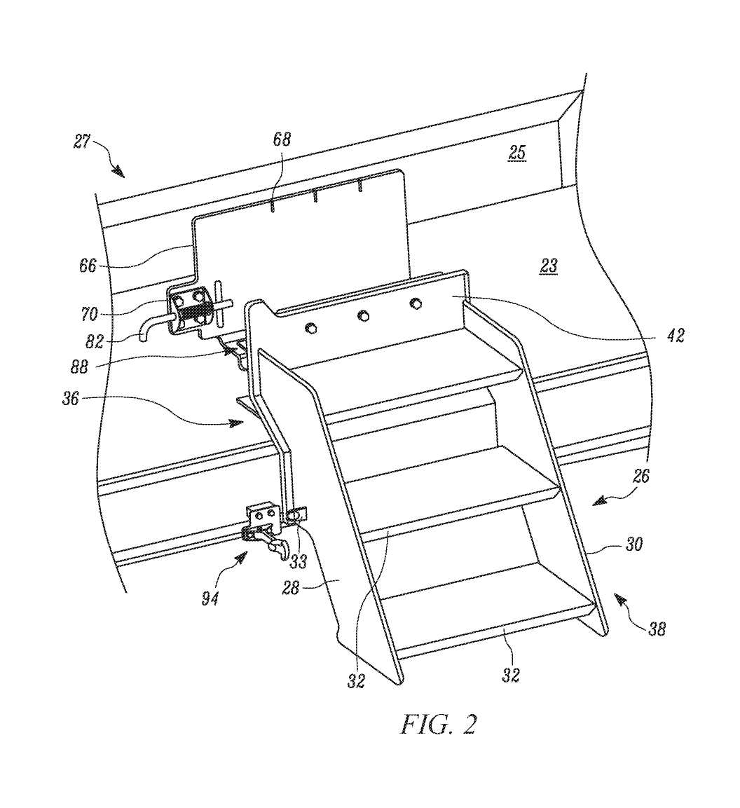

The machine 10 includes a frame 12 and an operator cabin 14 mounted on the frame 12 to control movement of the machine 10. The machine 10 further includes a plurality of ground engaging members 16 for propelling the machine 10 over a ground surface. The operator cabin 14 includes control levers for operating and driving the machine 10. The machine 10 may include a dump body (not shown). The frame 12 is adapted to pivotally support the dump body thereon. The machine 10 includes an engine room 22 located underneath a hood 21. The hood 21 is coupled to the frame 12 of the machine 10. The engine room 22 includes a first beam 23 (shown in FIG. 2) and a second beam 25 (shown in FIG. 2) coupled to the frame 12 of the machine 10.

The machine 10 includes an engine 24 disposed within the engine room 22. The engine 24 is mounted on the frame 12 and provides driving power to the ground engaging members 16 for propelling the machine 10 over the ground surface, The machine 10 further includes a ladder assembly 26 to provide access to the engine 24 in the engine room 22. The ladder assembly 26 allows an operator to access the engine 24 from the platform 18.

FIG. 2 illustrates a perspective view of a mounting arrangement 27 used for coupling the ladder assembly 26 with the frame 12 of the machine 10. The ladder assembly 26 includes a first side member 28, a second side member 30, and a plurality of steps 32 coupled between the first side member 28 and the second side member 30. The first side member 28 includes a coupling member 33 coupled to a lower portion of the ladder assembly 26. Similarly, another coupling member is coupled to a lower portion of the second side member 30.

The ladder assembly 26 includes a first end 36 adapted to connect to the frame 12 and a second end 38 disposed away from the frame 12. The frame 12 may include a plurality of brackets or blocks on the first beam 23 of the frame 12 to facilitate mounting of the ladder assembly 26 to the frame 12 of the machine 10 using the mounting arrangement 27. The mounting arrangement 27 includes a support member 42 connected to the first end 36 of the ladder assembly 26. Further, the support member 42 supports the ladder assembly 26 to the first beam 23 of the frame 12. The support member 42 is connected to the first end 36 of the ladder assembly 26 using various methods including, but not limited to, welding, riveting, bolting or any other methods known in the art.

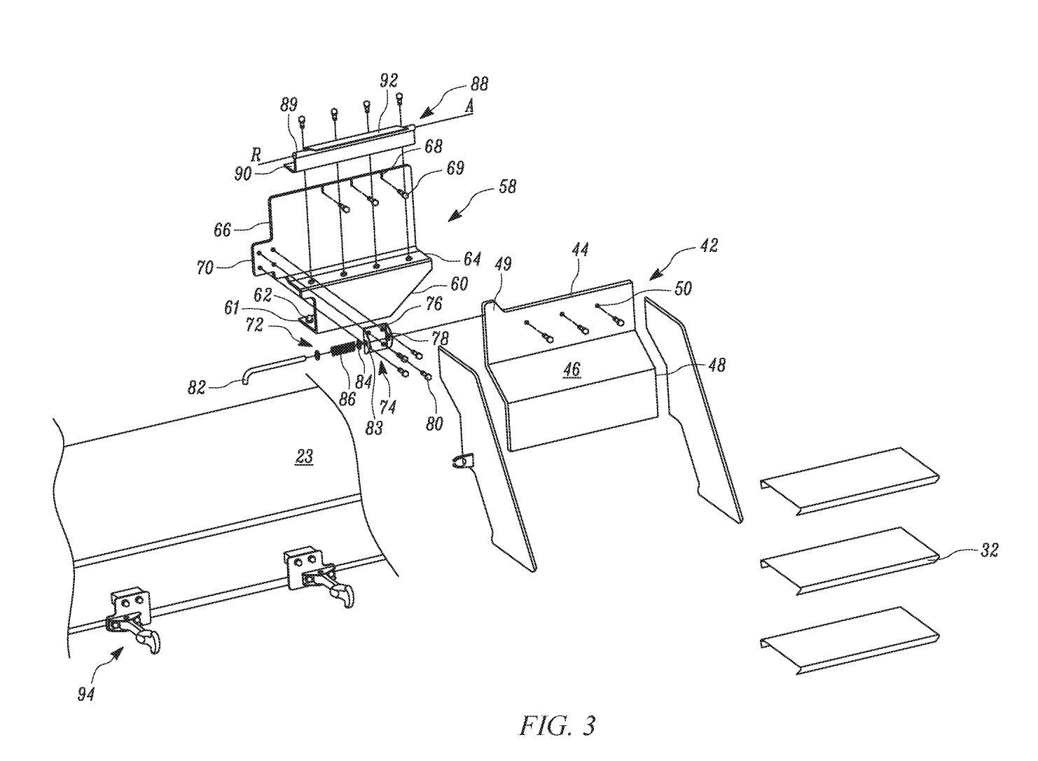

FIG. 3 illustrates an exploded view of the mounting arrangement 27 used for coupling the ladder assembly 26 with the frame 12 of the machine 10. The support member 42 includes a first flange 44, a second flange 46 and a third flange 48. The first flange 44, the second flange 46 and the third flange 48 of the support member 42 are coupled to the first and second side members 28, 30 of the ladder assembly 26 adjacent to the first end 36 thereof. In an example, the first flange 44 and the second flange 46 of the support member 42 are bent at an angle with respect to each other. Similarly, the second flange 46 and the third flange 48 of the support member 42 are bent at an angle with respect to each other. The support member 42 further includes a first extended portion 49 extending from the first flange 44 of the support member 42.

The first flange 44 of the support member 42 includes a plurality of holes 50. The mounting arrangement 27 includes a mounting member 58. The mounting member 58 is adapted to connect to the support member 42 and the frame 12 of the machine 10. The mounting member 58 includes a first flange portion 60. The first flange portion 60 is coupled to the first beam 23 via a number of first fastening members 62. More specifically, the first flange portion 60 further includes a coupling portion 61 that is coupled to the first beam 23 via the first fastening members 62. The number of first fastening members 62 is bolts and nuts. However, the first fastening members may be rivets or any other fastening elements known in the art. The mounting member 58 includes a second flange portion 64. The second flange portion 64 extends from the first flange portion 60. The mounting member 58 further includes a third flange portion 66. The third flange portion 66 extends from the second flange portion 64 and includes a plurality of slots 68. The plurality of slots 68 is adapted to receive a number of second fastening members 69. The third flange portion 66 is adapted to couple to the hood 21 of the frame 12 via the number of second fastening members 69. The number of second fastening members 69 includes nuts and bolts.

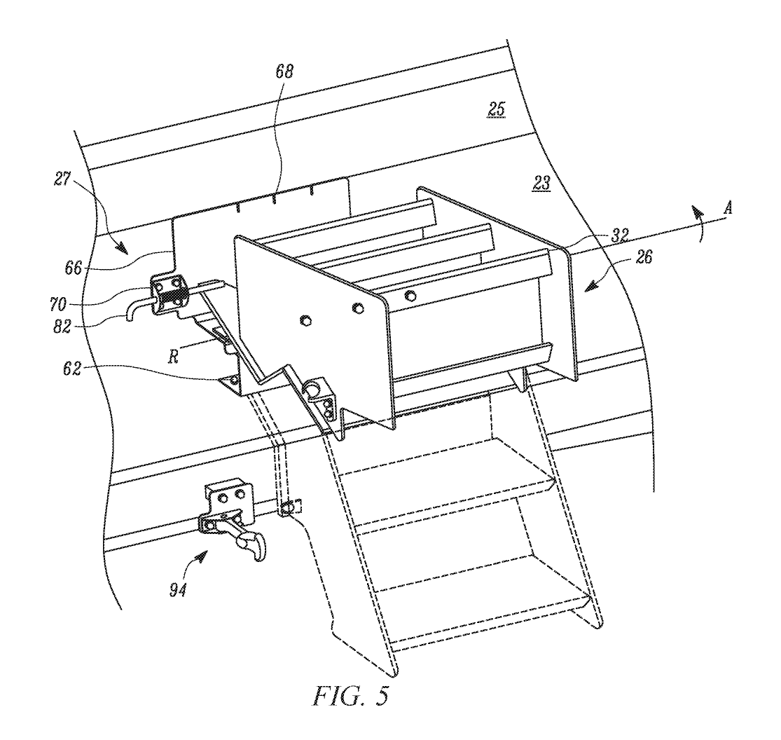

The mounting member 58 further includes a second extended portion 70. The second extended portion 70 extends from the third flange portion 66. The mounting arrangement 27 further includes a first latch assembly 72 adapted to hold the ladder assembly 26 in a displaced position (shown in FIG. 5). The first latch assembly 72 includes a first mounting bracket 74 coupled to the third flange portion 66 of the mounting member 58. More particularly, the first mounting bracket 74 is coupled to the second extended portion 70 of the mounting member 58. As shown in FIG. 3, the first mounting bracket 74 includes a base member 76, and a pair of flange faces 78 extending from the base member 76. The base member 76 is fastened to the second extended portion 70 via a number of third fastening members 80. The third fastening members 80 include nuts and bolts.

The first latch assembly 72 includes a first latch member 82. The first latch member 82 extends through a hole 83 provided in each of the pair of flange faces 78. In an example, the first latch member 82 may be an “L” shaped elongated bar, a rod, a pin or the like. The first latch member 82 may include an annular ring 84. The annular ring 84 is attached to the first latch member 82 and lies between the pair of flange faces 78. A spring 86 is extending between the pair of flange faces 78 such that, one end of the spring 86 abuts one of the side flange faces 78 and another end abuts the annular ring 84 of the first latch member 82. The first latch member 82 moves between an extended position and a retracted position against a biasing force of the spring 86.

The mounting arrangement 27 further includes a hinge member 88. The hinge member 88 is disposed between the support member 42 and the mounting member 58. The hinge member 88 includes a first flange member 90. The first flange member 90 is attached to the second flange portion 64 of the mounting member 58. The hinge member 88 includes a second flange member 92. The second flange member 92 is coupled to the first flange 44 of the support member 42. The hinge member 88 may include a pin 89 for rotatably connecting the first flange member 90 and the second flange member 92, The first flange member 90 and the second flange member 92 are rotated about a rotational axis ‘RA’ of the hinge member 58, In an example, the pin 89 may define the rotational axis ‘RA’.

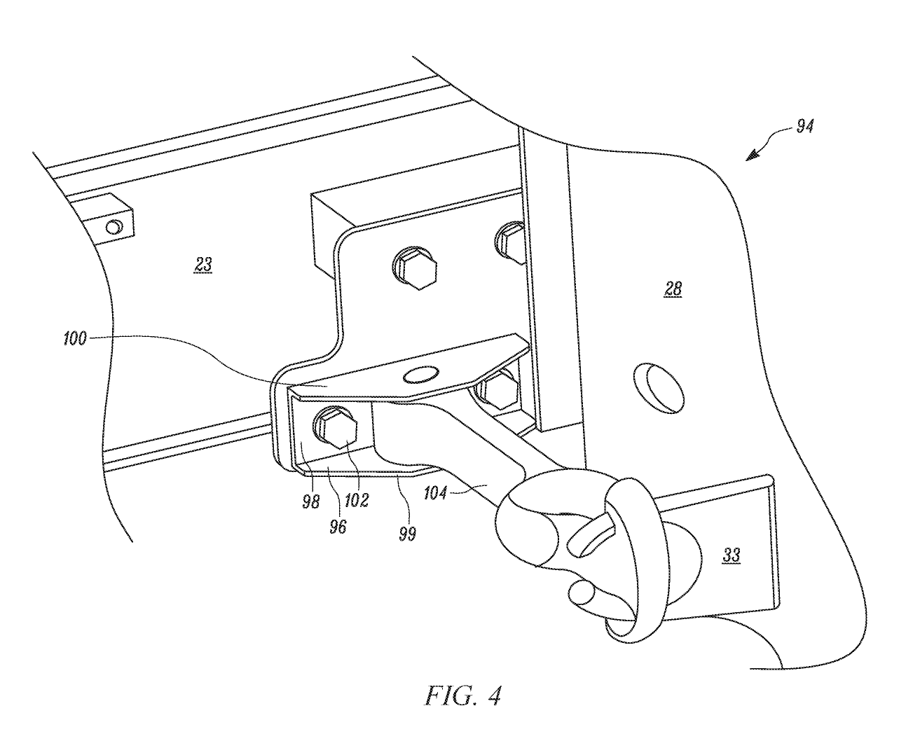

Referring to FIG. 4 the second latch assembly 94 is adapted to couple the ladder assembly 26 with the first beam 23 of the frame 12 of the machine 10. The second latch assembly 94 includes a second mounting bracket 96. (This bracket 96 is a single part. The second mounting bracket 96 includes a base portion 98, and a pair of flange faces 99. The base portion 98 is fastened to the first beam 23 via a number of fourth fastening members 102. The fourth fastening members 102 are bolts.

The second latch assembly 94 further includes a second latch member 104. The second latch member 104 is pivoted to the bracket 96 by a pin. This pivot will allow the second latch member 104 to rotate about the vertical axis. The second latch member 104 engages with the coupling member 33 coupled to the first side member 28 of the ladder assembly 26 to hold the ladder assembly 26 in a normal position thereof. In the normal position of the ladder assembly 26, the operator may walk down the ladder assembly 26 to access the engine 24 for maintenance and servicing purpose. The second latch member 104 disengages from the coupling member 33 to release the ladder assembly 26 from the normal position to the displaced position. The ladder assembly 26 is moved from the normal position to the displaced position about the rotational axis ‘RA’ (FIG. 3) during dismantling of the engine 24 from the engine room 22. Although, only one second latch assembly 94 is shown, it should be noted that the mounting arrangement 27 may include multiple second latch assemblies 94 on either sides of the ladder assembly 26.

In an alternate embodiment, the third flange 48 of the support member 42 may include a plurality of apertures (not shown). The plurality of apertures is aligned with the blocks present on the first beam 23 associated with the frame 12. A plurality of bolts (not shown) is fastened through the plurality of apertures affixing the support member 42 with the first beam 23 of the frame 12. Alternatively, a plurality of rivets, screws or any other fastening elements known in the art (not shown) may be used to fasten the support member 42 to the first beam 23 of the frame 12.

### INDUSTRIAL APPLICABILITY

Referring to FIG. 1 accessing the engine 24 disposed inside the engine room 22 from the hood 21 of the machine 10 by a service personnel or the operator requires the ladder assembly 26. The ladder assembly 26 is moved between the normal position and the displaced position during assembly or disassembly of the engine 24 within the engine room 22. The mounting arrangement 27 of the present disclosure is implemented in such a way that interference of the ladder assembly 26 with the engine 24 during the assembly or disassembly of the engine 24 may be eliminated to better facilitate the access to the engine 24 by the service personnel or the operator.

Referring to FIG. 5 the present disclosure relates to the mounting arrangement 27 that is used to position the ladder assembly 26 in the normal position and the displaced position. In the normal position of the ladder assembly 26, as shown in FIG. 2, the second latch assembly 94 is engaged with the coupling member 33 of the ladder assembly 26. The second latch assembly 94, firmly couple the ladder assembly 26 to the first beam 23 of the frame 12. The ladder assembly 26, in the normal position, allows the service personnel to easily climb up or climb down the plurality of steps 32 of the ladder assembly 26 and to access the engine 24 present in the engine room 22.

During the assembly or disassembly of the engine 24, for servicing purposes, the ladder assembly 26 that is positioned in the normal position is moved about the rotational axis ‘RA’ of the hinge member 88 to the displaced position as shown in FIG. 5. For this purpose, the ladder assembly 26 is moved to the displaced position by disengaging the second latch member 104 from the coupling member 33 of the ladder assembly 26. Further, the support member 42 along with the ladder assembly 26 is moved about the rotational axis ‘RA’ of the hinge member 88, and engaging the first latch assembly 72 with the first extended portion 49 of the first flange 44 of the support member 42. Thereby, locking the support member 42 along with the ladder assembly 26 in the displaced position. After servicing of the engine 24, the ladder assembly 26 may be moved back to the normal position by pivoting the support member 42 along with the ladder assembly 26.

Further, when the machine 10 is traveling, the ladder assembly 26 can be folded to the normal position. As such, the normal position of the ladder assembly 26 will minimize vibrations in the ladder assembly 26 and also prevents the ladder assembly 26 from striking against any obstacles. The mounting arrangement 27 enhances the life of the ladder assembly 26 and improves safety during operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting arrangement for a ladder assembly of a machine, the mounting arrangement comprising:
a support member connected to the first end of the ladder assembly;
a mounting member adapted to connect to the support member and the frame of the machine, the mounting member including:
a first flange portion coupled to a first beam associated with the frame of the engine room via a plurality of first fastening members;
a second flange portion extending from the first flange portion; and
a third flange portion extending from the second flange portion, the third flange portion coupled to a second beam associated with the frame of the machine via a plurality of second fastening members;
a hinge member disposed between the support member and the mounting member, the hinge member including:
a first flange member attached to the second flange portion of the mounting member; and
a second flange member coupled to the support member, wherein the first flange member and the second flange member are coupled with each other to move the ladder assembly between a normal position and a displaced position about a rotational axis of the hinge member;
a first latch assembly adapted to hold the ladder assembly in the displaced position, the first latch assembly including:
a first mounting bracket coupled to the third flange portion of the mounting member; and
a first latch member coupled to the first mounting bracket, wherein the first latch member engages the support member with the third flange portion of the mounting member in the displaced position of the ladder assembly, wherein the first latch member disengages the support member from the third flange portion of the mounting bracket in the normal position of the ladder assembly; and
a second latch assembly adapted to couple the ladder assembly with the first beam associated with the frame of the machine, the second latch assembly including:
a second mounting bracket coupled to the first beam; and
a second latch member coupled to the second mounting bracket, wherein the second latch member engages the ladder assembly with the first beam in the normal position of the ladder assembly, and wherein the second latch member disengages the ladder assembly from the first beam in the displaced position of the ladder assembly.
